(19) United States
(12) Patent Application Publication
(10) Pub. No.: US 2025/0263146 A1
(43) Pub. Date: Aug. 21, 2025

(54) WIRELESS CONTROLLER

(71) Applicant: Know Fast Smart Technology CO., LTD., Hsinchu City (TW)

(72) Inventors: CHIH-HAN LIN, Hsinchu City (TW); CHENG-CHUN TSAI, Hsinchu City (TW)

(21) Appl. No.: 18/669,115

(22) Filed: May 20, 2024

(30) Foreign Application Priority Data
Feb. 19, 2024 (TW) 113105829

(51) Int. Cl. B62K 23/00; B62J 1/08; B62J 6/165; B62J 45/414; B62J 50/22; B62K 25/04

(52) U.S. Cl. CPC B62K 23/00; B62J 1/08; B62J 6/165; B62J 45/414; B62J 50/22; B62K 25/04; B62K 2025/048

(57) ABSTRACT

A wireless controller, used in a bicycle having at least one of controllable devices, wherein the wireless controller has a housing, a wireless communication unit, a control unit, a rotary knob and a plurality of buttons. The wireless communication unit and the control unit are disposed in the housing, and the rotary knob and the buttons are disposed outside the housing. The wireless communication unit receives or transmits at least one signal. The control unit generates a control signal in response to a user command and transmits the control signal to the controllable device of the bicycle via the wireless communication unit to activate the controllable device of the bicycle. The rotary knob generates the user command to the control unit through a rotation operation, and button generates the user command to the control unit through a pressing operation.

### TECHNICAL FIELD

The present disclosure relates to a wireless controller, and in particular to a wireless controller used in a bicycle.

### RELATED ART

In addition to being a means of transportation, a bicycle can also be used as a leisure activity. More and more people regard riding bicycles as an entertainment activity and add many devices on or in the bicycles to increase comfort and operability, such as shock absorbers or lighting devices. During the riding process of a bicycle, the shock absorber is mainly relied on to reduce the vibration from the road surface, thereby reducing the fatigue and discomfort of the user. In addition, the height of the seat cushion of the bicycle (or the length of the seat pillar) will also affect the user to operate the bicycle and physical exertion. The damping of the traditional shock absorber of the bicycle and the height of the seat cushion are fixed. If the user wants to adjust the damping of the shock absorber or the height of the seat cushion, the user must stop the bicycle and manually adjust the shock absorber or the seat pillar which is connected to the seat cushion. It is not very convenient in operation, and it is also impossible to make real-time adjustments according to different road conditions.

Although some technical solutions have been proposed to address the above-mentioned problems so that the effect of real-time adjustment of the shock absorber or seat pillar length can be achieved, this still requires manual adjustment, so the user still needs to spend effort to observe and adapt to different road conditions to make better adjustments, but the bicycle itself other devices cannot automatically judge road conditions and make adjustments.

In addition, since bicycles are equipped with more and more devices, and these devices are independently controlled, it is not convenient in the operation.

Therefore, the solution how to provide a control manner that can integrate all controllable devices installed on a bicycle, and the solution how to make immediate and appropriate adjustments to the shock absorber or seat cushion height of the bicycle are urgent needs for those having ordinary skills in the art.

### SUMMARY

The present disclosure provides a wireless controller, used in a bicycle comprising at least one of controllable devices, wherein the wireless controller comprises a housing, a wireless communication unit, a control unit, a rotary knob and a plurality of buttons. The wireless communication unit is disposed in the housing and configured to receive and transmit at least one signal. The control unit is disposed in the housing and electrically connected to the wireless communication unit. The control unit is configured to generate a control signal in response to a user command and transmit the control signal to the controllable device of the bicycle via the wireless communication unit to activate the controllable device of the bicycle. The rotary knob is disposed outside the housing and connected to the control unit. The rotary knob is configured to generate the user command to the control unit through a rotation operation. The buttons are arranged outside the housing and connected to the control unit, wherein the buttons are configured to generate the user command to the control unit through a pressing operation.

According to one embodiment of the present disclosure, the at least one of the controllable devices comprises a shock absorber. The shock absorber comprises a hydraulic unit. In response to the rotation operation of rotating the rotary knob in a first rotation direction or the pressing operation of pressing a first one of the buttons, the generated user command corresponds to the control signal that activates the hydraulic unit of the shock absorber to increase a damping value of the shock absorber; and in response to the rotation operation of rotating the rotary knob in a second rotation direction or the pressing operation of pressing a second one of the buttons, the generated user command corresponds to the control signal that activates the hydraulic unit of the shock absorber to decrease the damping value of the shock absorber, wherein the first rotation direction is opposite to the second rotation direction.

According to one embodiment of the present disclosure, the at least one of the controllable devices comprises a telescopic seat pillar structure, and the telescopic seat pillar structure comprises a motor unit. In response to the rotation operation of rotating the rotary knob in a first rotation direction or the pressing operation of pressing a first one of the buttons, the generated user command corresponds to the control signal that activates the motor unit of the telescopic seat pillar structure to extend a telescopic length of the telescopic seat pillar structure; and in response to the rotation operation of rotating the rotary knob in a second rotation direction or the pressing operation of pressing a second one of the buttons, the generated user command corresponds to the control signal that activates the motor unit of the telescopic seat pillar structure to shorten the telescopic length of the telescopic seat pillar structure, wherein the first rotation direction is opposite to the second rotation direction.

According to one embodiment of the present disclosure, the wireless controller comprises another one button. The other one button is disposed outside the housing and connected to the control unit. The other one button is configured to generate the user command to the control unit through the pressing operation. In response to the pressing operation of pressing the other one button, the generated user command corresponds to the control signal that activates the motor unit to adjust the telescopic length of the telescopic seat pillar structure to be a maximum length or a minimum length.

According to one embodiment of the present disclosure, the at least one of the controllable devices comprises a lighting device, and the lighting device comprises a driving unit. In response to the rotation operation of rotating the rotary knob in a first rotation direction or the pressing operation of pressing a first one of the buttons, the generated user command corresponds to the control signal that activates the driving unit of the lighting device to increase brightness of the lighting device; and in response to the rotation operation of rotating the rotary knob in a second rotation direction or the pressing operation of pressing a second one of the buttons, the generated user command corresponds to the control signal that activates the driving unit of the lighting device to decrease the brightness of the lighting device, wherein the first rotation direction is opposite to the second rotation direction.

According to one embodiment of the present disclosure, the wireless controller further comprises an acceleration sensing unit and a gyroscope unit. The acceleration sensing unit is electrically connected to the control unit and configured to sense an acceleration variation to generate an acceleration signal. The gyroscope unit is electrically connected to the control unit and configured to sense an angular momentum variation to generate an angular velocity signal. The control unit is further configured to generate a velocity value based on the acceleration signal and the angular velocity signal.

According to one embodiment of the present disclosure, the wireless controller further comprises a display unit electrically connected to the control unit, and the display unit is configured to display the velocity value.

According to one embodiment of the present disclosure, the wireless controller further comprises a display unit electrically connected to the control unit. The bicycle further comprises at least one tire pressure sensor, and the display unit is configured to display tire pressure information of the at least one tire pressure sensor.

According to one embodiment of the present disclosure, the wireless controller further comprises a display unit electrically connected to the control unit. The at least one of the controllable devices comprises a shock absorber or a telescopic seat pillar structure, and the display unit is configured to display damping value information of the shock absorber or telescopic length information of the telescopic seat pillar structure.

According to one embodiment of the present disclosure, the wireless controller comprises an acceleration sensing unit and a gyroscope unit. The acceleration sensing unit is electrically connected to the control unit and configured to sense an acceleration variation to generate an acceleration signal. The gyroscope unit is electrically connected to the control unit and configured to sense an angular momentum variation to generate an angular velocity signal. The control unit is further configured to generate a gravity value based on the acceleration signal and the angular velocity signal.

According to one embodiment of the present disclosure, the at least one of the controllable devices comprises a shock absorber. In response to a smart mode, when a damping value of the shock absorber corresponding to the gravity value generated by the control unit is between a lower limitation value and an upper limitation value, the control unit generates the control signal for adjusting the damping value of the shock absorber according to the gravity value.

According to one embodiment of the present disclosure, the smart mode is switched to be one of a road mode, an off-road mode and a customized mode. Only when the damping value of the shock absorber corresponding to the gravity value generated by the control unit is between a set lower limitation value and a set upper limitation value of the current smart mode, the control unit generates the control signal for adjusting the damping value of the shock absorber according to the gravity value, wherein a set upper limitation value set of the off-road mode is larger than a set upper limitation value set of the road mode, a set lower limitation value set of the off-road mode is larger than a set lower limitation value set of the road mode, and a upper limitation value and a lower limitation value of the customized mode are determined by a user.

According to one embodiment of the present disclosure, the wireless controller further comprises a distance sensing unit. The distance sensing unit is disposed outside the housing and electrically connected to the control unit. The distance sensing unit is configured to transmit and receive a sensing signal and determine a distance between an object and the wireless controller based on a time difference between transmission and reception of the sensing signal.

According to one embodiment of the present disclosure, the control unit is further configured to generate the control signal in response to the distance of the object from the wireless controller and transmit the control signal to the controllable device of the bicycle via the wireless communication unit to activate the controllable device of the bicycle.

To sum up, the wireless controller of the present disclosure has multiple input modes to generate the user command to the control unit to implement wireless control of multiple controllable devices (such as shock absorber, telescopic seat pillar structure, lighting device, etc.) installed on the bicycle. It can include, for example, a rotary knob mode, a multi-button mode and single-button mode, making it more flexible and convenient to use. The wireless controller of the present disclosure also has a smart operation with a smart mode, the smart mode can be switched to one of a road mode, an off-road mode and a customized mode. Without the need for manual control (such as pressing or rotating), the control unit can calculate the gravity value based on the sensed acceleration signal and angular velocity signal, and compare gravity value with the set lower limitation value and upper limitation value to decide whether to adjust the shock absorber of the bicycle autonomously, thus achieving more convenient and labor-saving riding.

### BRIEF DESCRIPTIONS OF DRAWINGS

One embodiment of the present disclosure can be understood from the following detailed description when read in conjunction with the accompanying drawings. It is emphasized that, in accordance with standard industry practice, various features are not drawn to scale but for illustrative purposes only. In fact, the dimensions of the various features may be arbitrarily increased or reduced for clarity of explanation.

FIG. 1A is a schematic block diagram of a wireless controller according to one embodiment of the present disclosure.

FIG. 1B is a schematic plan view of an entity structure of a wireless controller according to one embodiment of the present disclosure.

FIG. 2 is a schematic block diagram of a plurality of controllable devices of a bicycle according to one embodiment of the present disclosure.

FIG. 3 is a schematic curve diagram showing relationship of a gravity value and a rotation angle.

### DETAILS OF EMBODIMENTS

The following embodiments of the present disclosure provide different implementations, or examples, for implementing various features of the provided subject matter. Specific examples of components and arrangements described below may simplify the technology of the present disclosure. Of course, these examples are exemplary examples only and are not used to limit the present disclosure. Additionally, reference symbols and/or letters may be repeated in each embodiment. This repetition is for simplicity and clarity and does not by itself specify a relationship between the various embodiments and/or configurations discussed.

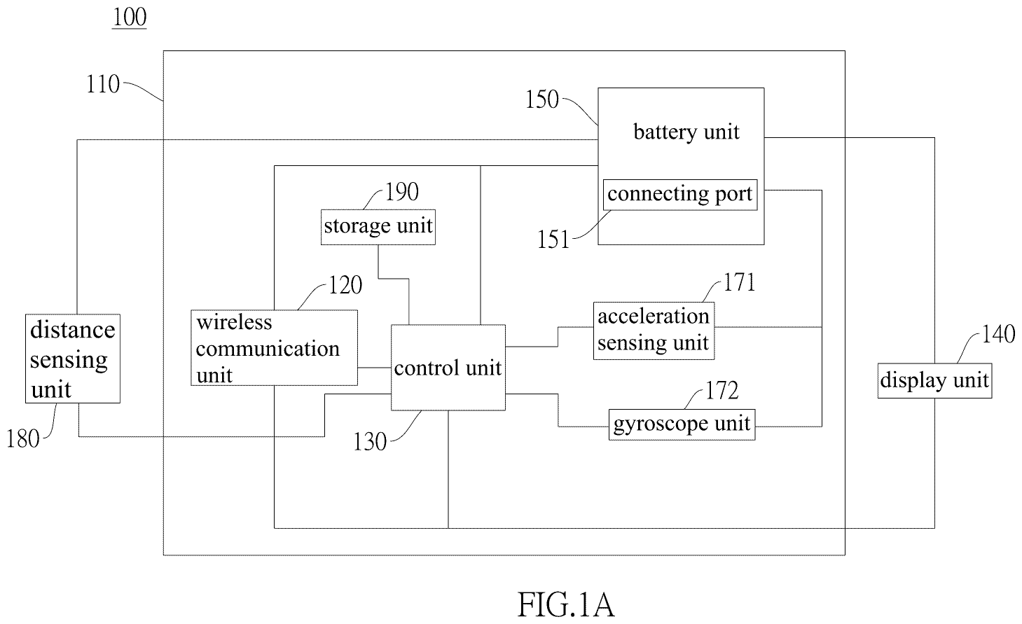

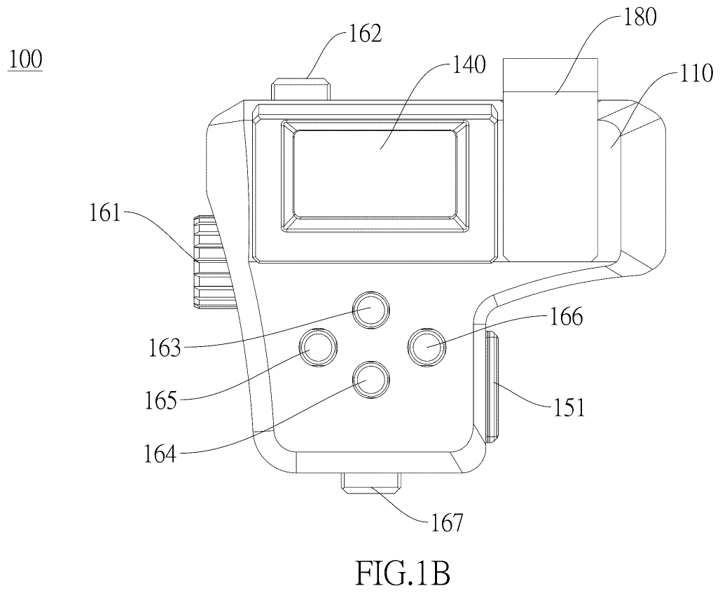

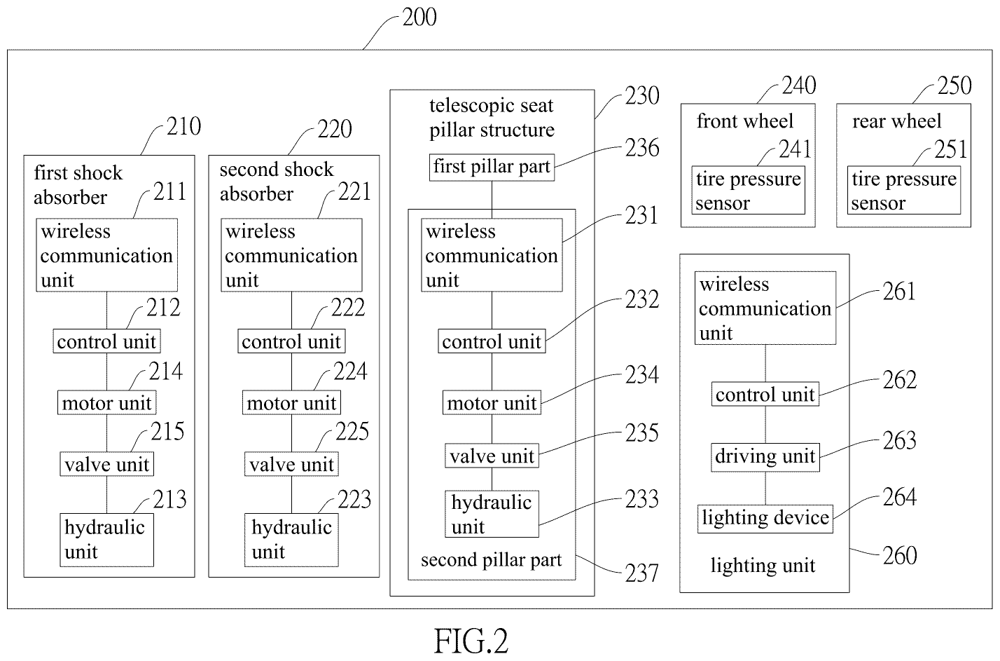

Refer to FIG. 1A, FIG. 1B and FIG. 2, FIG. 1A is a schematic block diagram of a wireless controller 100 according to one embodiment of the present disclosure, FIG. 1B is a schematic plan view of an entity structure of the wireless controller 100 according to one embodiment of the present disclosure, and FIG. 2 is a schematic block diagram of a plurality of controllable devices of a bicycle 200 according to one embodiment of the present disclosure. As shown in FIG. 2, the bicycle 200 can include a plurality of controllable devices installed on the bicycle 200, such as, but not limited to, at least one shock absorber (in this example, two shock absorbers are shown, a first shock absorber 210 and a second shock absorber 220), a telescopic seat pillar structure 230 and a lighting device 260. The first shock absorber 210 can be, for example, a front fork shock absorber, and the second shock absorber 220 can be, for example, a rear fork shock absorber. The telescopic seat pillar structure 230 can be connected to the seat cushion to adjust the height of the seat cushion. The lighting device 260 can be, for example, an LED element to provide visual sight at night. Specifically, the wireless controller 100 can also be installed on the bicycle 200 (for example, a handle), and can wirelessly control all controllable devices installed on the bicycle 200 (in this example, the first shock absorber 210, the second shock absorber 220, the telescopic seat pillar structure 230 and the lighting device 260), thereby enabling a single controller to control multiple controllable devices on the bicycle 200 in real time and at the same time when riding the bicycle 200, without having to stop the bicycle and manually adjust these controllable devices.

As shown in FIG. 1A, in this embodiment, the wireless controller 100 can include a housing 110, a wireless communication unit 120, a control unit 130, a display unit 140 and a battery unit 150. The wireless communication unit 120, the control unit 130, and the battery unit 150 are all installed in the housing 110, so they are not shown in FIG. 1B.

The wireless communication unit 120 can include a receiver for receiving signals and a transmitter for transmitting signals. In one embodiment, the wireless communication unit 120 can utilize Bluetooth, WI-FI, NearLink, Zigbee, or other similar short-range communication protocols for signal transmission.

The control unit 130 is electrically connected to the wireless communication unit 120, and is configured to generate a control signal to the wireless communication unit 120 according to the received user command, and transmit the control signal to the first shock absorber 210, the second shock absorber 220, the telescopic seat pillar structure 230, and/or the lighting device 260 of the bicycle 200 through the wireless communication unit 120, so as to adjust these components. The specific details will be described later. In one embodiment, the function of the control unit 130 can be provided by, for example, a microprocessor, a microcontroller, a digital signal processing (DSP) chip, a field programmable gate array (FPGA), or other one programmable unit. The function of the control unit 130 can also be implemented by independent electronic devices or application specific integrated circuits (ASICs), and the present disclosure is not limited thereto.

The display unit 140 is electrically connected to the wireless communication unit 120 and the control unit 130 and is configured to display bicycle information or control options of the wireless controller 100. The specific details will be described later.

The battery unit 150 is electrically connected to the wireless communication unit 120, the control unit 130, and the display unit 140, and is configured to power these units. In one embodiment, the battery unit 150 includes a connecting port 151 (as shown in FIG. 1B). The connecting port 151 can connect a wire to receive externally provided power to charge the battery unit 150. The connecting port 151 can be, for example, a universal serial bus (USB) interface, such as type-A, type-B, type-C and other similar interfaces, but the present disclosure is not limited thereto.

In one operation, the control unit 130 can generate the control signal after receiving the user command input by the user and transmit the control signal to the wireless communication unit 120. The wireless communication unit 120 can wirelessly transmit the control signal to the corresponding one of the first shock absorber 210, the second shock absorber 220, the telescopic seat pillar structure 230 and the lighting device 260 to control these components. Specifically, as shown in FIG. 2, the first shock absorber 210 can include a wireless communication unit 211, a control unit 212, a hydraulic unit 213, a motor unit 214 and a valve unit 215. The wireless communication unit 211 is configured to receive and transmit the signals and can be paired with the wireless communication unit 120 by using the communication protocol of the wireless communication unit 120. The control unit 212 is electrically connected to the wireless communication unit 211 and the motor unit 214 and is configured to control a rotation angle of the motor unit 214. The valve unit 215 is connected to the hydraulic unit 213 and the motor unit 214 and can adjust the opening and closing degree thereof according to the rotation angle of the motor unit 214. The opening and closing degree of the valve unit 215 will affect the liquid flow speed (that is, the oil pressure) in the hydraulic unit 213, thereby changing the damping value of the first shock absorber 210. Therefore, when the control unit 130 of the wireless controller 100 transmits the control signal to the wireless communication unit 211 of the first shock absorber 210 via the wireless communication unit 120, and the control unit 212 of the first shock absorber 210 receives the control signal via the wireless communication unit 211, the rotation angle of the motor unit 214 can be adjusted to the angle set by the user command according to the control signal, so that the opening and closing degree of the valve unit 215 reaches the set level, thereby adjusting the oil pressure of the hydraulic unit 213 to make the damping value of the first shock absorber 210 reach the demand damping value which the user wants.

Similarly, the second shock absorber 220 can include a wireless communication unit 221, a control unit 222, a hydraulic unit 223, a motor unit 224 and a valve unit 225. The connection relationship and control means are the same as those of the first shock absorber 210, and the redundant descriptions are omitted herein.

The telescopic seat pillar structure 230 can include a wireless communication unit 231, a control unit 232, a hydraulic unit 233, a motor unit 234, a valve unit 235, a first pillar part 236 and a second pillar part 237. The first pillar part 236 is connected to the second pillar part 237, and the hydraulic unit 233, the motor unit 234 and the valve unit 235 are arranged in the second pillar part 237. The first pillar part 236 can be connected to the seat cushion. The second pillar part 237 can move relative to the first pillar part 236 according to the oil pressure variation of the hydraulic unit 233. The wireless communication unit 231 is configured to receive and transmit the signals, and can be paired with the wireless communication unit 120 by using the communication protocol of the wireless communication unit 120. The control unit 232 is electrically connected to the wireless communication unit 231 and the motor unit 234, and is configured to control the rotation angle of the motor unit 234. Similarly, the valve unit 235 is connected to the hydraulic unit 233 and the motor unit 234, and can adjust the opening and closing degree thereof according to the rotation angle of motor unit 234. The opening and closing degree of valve unit 235 will affect the oil pressure in hydraulic unit 233, thus changing the movement direction and distance of the second pillar part 237 relative to the first pillar part 236. Therefore, when the control unit 130 of the wireless controller 100 transmits the control signal to the wireless communication unit 231 of the telescopic seat pillar structure 230 via the wireless communication unit 120, and the control unit 232 of the telescopic seat pillar structure 230 receives the control signal via the wireless communication unit 231, the rotation angle of the motor unit 234 can be adjusted to the angle set by the user command according to the control signal, so that the opening and closing degree of the valve unit 235 reaches the set level, thereby adjusting the oil pressure of the hydraulic unit 233 to adjust the relative distance between the second pillar part 237 and the first pillar part 236 (that is, adjust the telescopic length of the telescopic seat pillar structure 230 to the length that the user wants to achieve). Accordingly, the height adjustment of the seat cushion can be implemented.

The lighting device 260 can include a wireless communication unit 261, a control unit 262, a driving unit 263 and a lighting unit 264. The wireless communication unit 261 is configured to receive and transmit the signals, and can be paired with the wireless communication unit 120 by using the communication protocol of the wireless communication unit 120. The control unit 262 is electrically connected to the wireless communication unit 261 and the driving unit 263. In one embodiment, the lighting unit 264 can be a light emitting diode (LED) array. The driving unit 263 can include a switching circuit, a voltage adjustment circuit to provide a stable voltage, or a current adjustment circuit to provide a stable current to the lighting unit 264. The control unit 262 adjusts the voltage provided by the voltage adjustment circuit or the current provided by the current adjustment circuit by controlling the switching cycle or frequency of the switching circuit of the driving unit 263. Therefore, when the control unit 130 of the wireless controller 100 transmits the control signal to the wireless communication unit 261 of the lighting device 260 via the wireless communication unit 120, and the control unit 262 of the lighting device 260 receives the control signal via the wireless communication unit 261, the output voltage or output current of the driving unit 263 can be adjusted according to this control signal, such that the output voltage or output current of the driving unit 263 is adjusted to the magnitude set by the user command, and the brightness of the lighting unit 264 is adjusted.

Through the above manner, the user command can be input to the control unit 130 to realize wireless control and adjust the damping value of the shock absorber, the height of the seat cushion or the brightness of the lighting device. In the wireless controller 100 proposed in the present disclosure, a manner of inputting the user command to the control unit 130 is further disclosed.

As shown in FIG. 1B, the wireless controller 100 also structurally includes a rotary knob 161 and a plurality of buttons (in this example, six buttons 162-167 are shown). The rotary knob 161 and the buttons 162 to 167 are disposed outside the housing 110 and are configured for the user operation to generate the user command to the control unit 130. The rotary knob 161 is configured to generate the user command through the rotation operation, and buttons 162 to 167 are configured to generate the user command through the pressing operation.

In one embodiment, the user can turn on or off the wireless controller 100 by long pressing the button 162. At the same time, the user can adjust the screen and control options displayed by the display unit 140 by short pressing the button 162. For example, by short pressing the button 162, the display unit 140 can switch the display options or control options for the user to view. Among the display options, the user can choose to have the display unit 140 display the current information of the bicycle 200. In one example, information corresponding to the damping values of the first shock absorber 210 and the second shock absorber 220 can be displayed (in this example, the damping values of the first shock absorber 210 and the second shock absorber 210 can be represented by displaying the rotation angles of the motor units 214 and 224). Specifically, the information corresponding to the damping values of the first shock absorber 210 and the second shock absorber 220 can be transmitted to the control unit 130 of the wireless controller 100 via the wireless communication unit 211 of the first shock absorber 210 and the wireless communication unit 221 of the second shock absorber 220, and then can be displayed by the display unit 140. In another example, information corresponding to the telescopic length of the telescopic seat pillar structure 230 can be displayed (in this example, the telescopic length of the telescopic seat pillar structure 230 can be represented by displaying the rotation angle of the motor unit 234, that is, the relative distance between first pillar part 236 and second pillar part 237 can be represented by displaying the rotation angle of the motor unit 234). Specifically, the information corresponding to the telescopic length of the telescopic seat pillar structure 230 can be transmitted to the control unit 130 of the wireless controller 100 via the wireless communication unit 231 of the telescopic seat pillar structure 230, and then can be displayed by the display unit 140. In another example, information corresponding to the brightness of the lighting device 260 can be displayed. In other examples, other information can be displayed. For example, the front wheel 240 of the bicycle 200 can also be equipped with a tire pressure sensor 241, and the rear wheel 250 can also be equipped with a tire pressure sensor 251. Both the tire pressure sensors 241 and 251 include respective wireless communication units (not shown) for transmitting the sensed tire pressure information to the control unit 130 of the wireless controller 100, and the sensed tire pressure information can be displayed on the display unit 140. For another example, the display unit 140 can also display the current battery information of at least one of the battery unit 150 of the wireless controller 100, the tire pressure sensor 241 and the tire pressure sensor 251.

Among the control options, the user can choose to have the display unit 140 display the control content that can be currently performed on the bicycle 200. In one example, the control content of the adjustment of the damping values of the first shock absorber 210 and the second shock absorber 220 of the bicycle 200 is displayed. In another example, the control content of the adjustment of the telescopic length of the telescopic seat pillar structure 230 of the bicycle 200 is displayed. In yet another example, the control content of the adjustment of the brightness of the lighting device 260 of the bicycle 200 is displayed. After selecting a control option which the user wants to control, the user command is generated to the control unit 130 by the user operation of operating the rotary knob 161 and the buttons 163 to 167, and then the control unit 130 generates the control signal according to the user command.

In one embodiment, the rotary knob 161 is configured to generate user command to the control unit 130 through the rotation operation. In response to the rotation operation of rotating the rotary knob 161 in a first rotation direction, the generated user command corresponds to the control signal that increases the damping values of the first shock absorber 210 and the second shock absorber 220, extends the telescopic length of the telescopic seat pillar structure 230, or increases the brightness of the lighting device 260; and in response to the rotation operation of rotating the rotary knob 161 in a second rotation direction, the generated user command corresponds to the control signal that decreases the damping values of the first shock absorber 210 and the second shock absorber 220, shortens the telescopic length of the telescopic seat pillar structure 230, or decreases the brightness of the lighting device 260, wherein the first rotation direction is opposite to the second rotation direction.

Specifically, when the user selects to adjust the damping values of the first shock absorber 210 and the second shock absorber 220 of the bicycle 200 through operating the button 162, the display unit 140 can display the corresponding damping values to be set (in this example, the rotation angles of the motor units 214 and 224 to be adjusted are displayed), the user can rotate the rotary knob 161 in the first rotation direction to increase the damping values of the first shock absorber 210 and the second shock absorber 220 (in the example, the increased rotation angles of the motor units 214 and 224 are displayed), and the user can rotate the rotary knob 161 in the second rotation direction to decrease the damping values of the first shock absorber 210 and the second shock absorber 220 (in the example, the decreased rotation angles of the motor units 214 and 224 are displayed), wherein the first rotation direction is opposite to the second rotation direction. After stopping operating the rotary knob 161 for a period of time, a corresponding user command can be generated to the control unit 130 according to the currently set value, and then the above operations associated with the components of the first shock absorber 210 and the second shock absorber 220 can be performed to adjust the damping values of the first shock absorber 210 and the second shock absorber 220.

Similarly, when the user selects to adjust the telescopic length of the telescopic seat pillar structure 230 of the bicycle 200 by operating the button 162, the display unit 140 can display the corresponding length to be set (in this example, the angle of the motor unit 234 to be adjusted can be displayed). Then, the above-mentioned process of operating the rotary knob 161 is performed to achieve the effect of adjusting the telescopic length of the telescopic seat pillar structure 230.

Similarly, when the user selects to adjust the brightness of the lighting device 260 of the bicycle 200 by operating the button 162, the display unit 140 can display the corresponding brightness to be set. Then, the above-mentioned process of operating the rotary knob 161 is performed to achieve the effect of adjusting the brightness of the lighting device 260.

In one embodiment, in response to the pressing operation of pressing the button 163, the generated user command corresponds to the control signal that increases the damping values of the first shock absorber 210 and the second shock absorber 220, extends the telescopic length of the telescopic seat pillar structure 230, or increases the brightness of the lighting device 260; and in response to the pressing operation of pressing the button 164, the generated user command corresponds to the control signal that decreases the damping values of the first shock absorber 210 and the second shock absorber 220, shortens the telescopic length of the telescopic seat pillar structure 230, or decreases the brightness of the lighting device 260.

Similarly, in addition to using the rotary knob 161 to adjust the damping values of the first shock absorber 210 and the second shock absorber 220, the telescopic length of the telescopic seat pillar structure 230, or the brightness of the lighting device 260 in an analogous manner, these controllable devices can be also adjusted digitally by pressing buttons 163 and 164.

Specifically, when the user selects to adjust the damping values of the first shock absorber 210 and the second shock absorber 220 of the bicycle 200 through operating the button 162, the display unit 140 can display the corresponding damping values to be set (in this example, the rotation angles of the motor units 214 and 224 to be adjusted are displayed), the user can press the button 163 to increase the damping values of the first shock absorber 210 and the second shock absorber 220 (in the example, the increased rotation angles of the motor units 214 and 224 are displayed), and the user can press the button 164 to decrease the damping values of the first shock absorber 210 and the second shock absorber 220 (in the example, the decreased rotation angles of the motor units 214 and 224 are displayed). After stopping operating the buttons 163 and 164 for a period of time, a corresponding user command can be generated to the control unit 130 according to the currently set value, and then the above operations associated with the components of the first shock absorber 210 and the second shock absorber 220 can be performed to adjust the damping values of the first shock absorber 210 and the second shock absorber 220.

Similarly, when the user selects to adjust the telescopic length of the telescopic seat pillar structure 230 of the bicycle 200 by operating the button 162, the display unit 140 can display the corresponding length to be set (in this example, the angle of the motor unit 234 to be adjusted can be displayed). Then, the above-mentioned process of operating the buttons 163 and 164 is performed to achieve the effect of adjusting the telescopic length of the telescopic seat pillar structure 230.

Similarly, when the user selects to adjust the brightness of the lighting device 260 of the bicycle 200 by operating the button 162, the display unit 140 can display the corresponding brightness to be set. Then, the above-mentioned process of operating the buttons 163 and 164 is performed to achieve the effect of adjusting the brightness of the lighting device 260.

In one embodiment, in response to the pressing operation of pressing the button 165, the generated user command corresponds to the control signal that adjusts the telescopic length of the telescopic seat pillar structure 230 to be a maximum length; and in response to the pressing operation of pressing the button 166, the generated user command corresponds to the control signal that adjusts the telescopic length of the telescopic seat pillar structure 230 to be a minimum length. Specifically, when the user does not want to make fine adjustments, the can directly generate the user command to adjust the telescopic length of the telescopic seat pillar structure 230 to be the maximum length by pressing the button 165 (in this example, the angle of the motor unit is adjusted to be the maximum angle), or directly generate the user command to adjust the telescopic length of the telescopic seat pillar structure 230 to be the minimum length (the angle of the motor unit is adjusted to be the minimum angle) by pressing the button 166. This operation manner can also be applied to adjust the damping values of the first shock absorber 210 and the second shock absorber 220 or the brightness of the lighting device 260. The implementation manner can be referred to the above and will not be described again herein.

In one embodiment, in response to the pressing operation of pressing the button 167, the generated user command corresponds to the control signal that adjusts the telescopic length of the telescopic seat pillar structure 230 to be the maximum length or the minimum length. Specifically, when the user does not want to make fine adjustments, in addition to directly pressing button 165 or 166, the user can also make adjustments only by pressing the single button 167. In one embodiment, when the button 167 is pressed once, the telescopic length of the telescopic seat pillar structure 230 is adjusted to be the maximum length, and when the button 167 is pressed again, the telescopic length of the telescopic seat pillar structure 230 is adjusted to be the minimum length, and vice versa. The operation manner can also be applied to adjust the damping values of the first shock absorber 210, the second shock absorber 220 or the brightness of the lighting device 260. The implementation manner can be referred to the above and will not be described again herein.

The above-mentioned input manner for generating the user command can be altered or modified accordingly without departing from the spirit of the present disclosure, and the present disclosure is not limited thereto.

The above-mentioned manner still requires the user to make manual adjustments according to the current road conditions or physical conditions of the user. The following will further describe how the wireless controller 100 of the present disclosure can automatically adjust the damping values of the first shock absorber 210 and the second shock absorber 220 of the bicycle 200.

Go back to refer to FIG. 1A, the wireless controller 100 can also include an acceleration sensing unit 171, a gyroscope unit 172 and a storage unit 190. The acceleration sensing unit 171, the gyroscope unit 172 and the storage unit 190 are all electrically connected to the control unit 130 and the battery unit 150. The acceleration sensing unit 171 is configured to sense the acceleration variation to generate an acceleration signal, and the gyroscope unit 172 is configured to sense the angular momentum variation to generate an angular velocity signal. The control unit 130 is also configured to generate a velocity value based on the acceleration signal and the angular velocity signal. Specifically, the control unit 130 can calculate the velocity value of the bicycle 200 installed with the wireless controller 100 at this time based on the acceleration signal sensed by the acceleration sensing unit 171 and the angular velocity signal sensed by the gyroscope unit 172. In one embodiment, the display unit 140 can also display the velocity value calculated by the control unit 130.

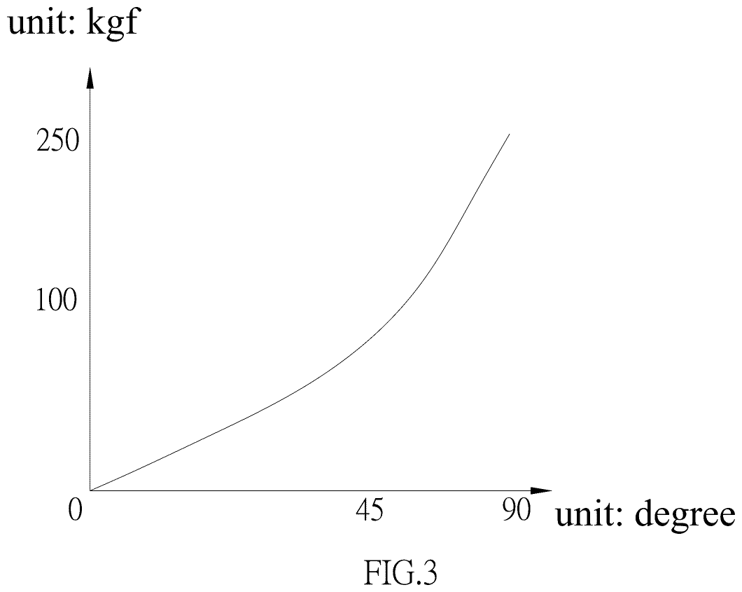

In addition, the control unit 130 can also generate a gravity value (the unit is kgf) based on the acceleration signal and the angular velocity signal. The gravity value can be calculated by using a predetermined function to obtain the corresponding rotation angle of the motor unit 214 and the motor unit 224. Refer to FIG. 3, and FIG. 3 is a schematic curve diagram showing relationship of a gravity value and a rotation angle. Specifically, the gravity value generated by the control unit 130 according to the acceleration signal and the angular velocity signal corresponds to the impact force of the first shock absorber 210 and the second shock absorber 220. Therefore, the damping values of the first shock absorber 210 and the second shock absorber 220 can be directly adjusted according to the gravity value.

In one embodiment, in response to a smart mode, when the damping value of the first shock absorber 210 and/or the damping value of the second shock absorber 220 corresponding to the gravity value generated by the control unit 130 are/is between a lower limitation value and an upper limitation value, the control unit 130 generates the control signal for adjusting the damping value of the first shock absorber 210 and/or the he damping value of the second shock absorber 220 according to the gravity value.

Specifically, the control mode options provided by the wireless controller 100 through the operating the button 162 also include a smart mode. The smart mode pre-sets the lower limitation value and the upper limitation value corresponding to the damping value of the first shock absorber 210 and/or the damping value of the second shock absorber 220 (in this example, they can be the lower limitation angle and the upper limitation angle of the rotation angle of the motor unit 214 and/or the rotation angle of the motor unit 224). When the user selects the smart mode, the control unit 130 will sense the acceleration signal and the angular velocity signal in a specific period to generate a gravity value. When the rotation angle converted by the generated gravity value is between the lower limitation angle and the upper limitation angle, the control unit 130 will automatically adjust the rotation angle of the motor unit 214 and/or the rotation angle of the motor unit 224 to be the rotation angle converted by the gravity value at this time. This control manner can be similar to the above embodiment, except that the control unit 130 generates the control signal not based on the user command but based on the gravity value. If the rotation angle converted by the generated gravity value is not between the lower limitation value and the upper limitation value, the control unit 130 will not adjust the damping value of the first shock absorber 210 and/or the damping value of the second shock absorber 220 (that is, the rotation angle of the motor unit 214 and/or the rotation angle the motor unit 224 are/is not adjusted).

In one embodiment, the smart mode is switched to be one of a road mode, an off-road mode and a customized mode, when the user selects smart mode to be one of the road mode, off-road mode and customized mode, the control unit 130 will determine whether the gravity value is between the lower limitation value and the upper limitation value, wherein the lower limitation value and the upper limitation value are set in the mode selected by the user. For example, in the road mode, the lower limitation angle of the rotation angle of the motor unit 214 and/or the rotation angle the motor unit 224 is set to 0, the upper limitation angle of the rotation angle of the motor unit 214 and/or the rotation angle the motor unit 224 is set to 45 degrees, and thus the corresponding gravity values are 0 and 100 kgf, respectively. For example, in the off-road mode, the lower limitation angle of the rotation angle of the motor unit 214 and/or the rotation angle the motor unit 224 is set to 35 degrees, the upper limitation value of the rotation angle of the motor unit 214 and/or the rotation angle the motor unit 224 is set to 90 degrees, and thus the corresponding gravity values are 50 and 250 kgf, respectively. In the customized mode, the user can set the desired lower limitation value and upper limitation value and store them in the storage unit 190. In this way, assuming that the user switches the smart mode to be the road mode, the control unit 130 will determine whether the currently calculated gravity value is between 0 and 100 kgf. If the currently calculated gravity value is between 0 and 100 kgf (for example, the gravity value is 25 kgf), the control unit 130 will automatically generate a control signal to adjust the rotation angle of the motor unit 214 and/or the rotation angle the motor unit 224 to be the rotation angle corresponding to 25 kgf. If the currently calculated gravity value is not between 0 and 100 kgf (for example, the gravity value is 150 kgf), the control unit 130 will not automatically adjust the rotation angle of the motor unit 214 and/or the rotation angle the motor unit 224.

Through the design of the above-mentioned smart mode, the wireless controller 100 of the present disclosure can also automatically adjust the damping value of the first shock absorber 210 and/or the damping value of the second shock absorber 220 of the bicycle 200 without human control. This results in more convenient and effortless riding.

In an embodiment, as shown in FIG. 1A and FIG. 1B, the wireless controller 100 can further include a distance sensing unit 180. The distance sensing unit 180 is arranged outside the housing 110 and is electrically connected to the control unit 130. The distance sensing unit 180 is configured to transmits and receives the sensing signal and determine the distance between the object and the wireless controller 100 based on the time difference between transmission and reception of the sensing signal.

In one embodiment, the distance sensing unit 180 can be, for example, an infrared sensor, a radar sensor, a light radar sensor, or other similar sensors. If the distance sensing unit 180 is an infrared sensor, the sensing signal can be an infrared signal. The distance sensing unit 180 can transmit the infrared signal to the object and determine the position of the object based on the degree of reflection or absorption of the infrared signal to estimate the distance between the object and the wireless controller 100. If the distance sensing unit 180 is a radar sensor, the sensing signal can be an electromagnetic wave signal. The distance sensing unit 180 can transmit the electromagnetic wave signal to the object and determine the position of the object and the distance between the object and the wireless controller 100 according to the transmission of the electromagnetic wave signal and the reception of the reflected electromagnetic wave signal. If the distance sensing unit 180 is a light radar sensor (or LiDAR sensor), the sensing signal can be a laser light signal. The distance sensing unit 180 can determine the position of the object and the distance between the object and the wireless controller 100 according to the transmission of the laser light signal and the reception of the reflected laser light signal.

Furthermore, the wireless controller 100 of the present disclosure can also automatically perform corresponding operations according to the distance between the object sensed by the distance sensing unit 180 and the wireless controller 100, or according to the position of the object sensed by the distance sensing unit 180. In one embodiment, the control unit 130 can also be configured to generate a control signal in response to the distance between the object sensed by the distance sensing unit 180 and the wireless controller 100, and the control signal is transmitted to at least one of the above-mentioned controllable devices via the wireless communication unit 120 to activate the corresponding controllable device. For example, when the user is riding a bicycle 200 equipped with the wireless controller 100, if the distance sensing unit 180 senses that there is a foreign object 100 meters directly in front, it will be displayed through the display unit 140, and the control unit 130 will automatically generate a control signal according to the distance of the foreign object sensed by the distance sensing unit 180 to the motor unit of at least one of the first shock absorber 210, the second shock absorber 220 and the telescopic seat pillar structure 230 to adjust the damping values of the first shock absorber 210 and the second shock absorber 220 and/or the telescopic length of the telescopic seat pillar structure 230. The specific details can be referred to the above embodiments and will not be described again here. To sum up, the wireless controller of the present disclosure has multiple input modes to generate the user command to the control unit to implement wireless control and real-time control of multiple controllable devices (such as shock absorber, telescopic seat pillar structure, lighting device, etc.) installed on the bicycle. It can include, for example, a rotary knob mode, a multi-button mode and single-button mode, making it more flexible and convenient to use. The wireless controller of the present disclosure also has a smart operation with a smart mode, the smart mode can be switched to one of a road mode, an off-road mode and a customized mode. Without the need for manual control (such as pressing or rotating), the control unit can calculate the gravity value based on the sensed acceleration signal and angular velocity signal, and compare gravity value with the set lower limitation value and upper limitation value to decide whether to adjust the shock absorber of the bicycle autonomously, thus achieving more convenient and labor-saving riding.

The foregoing summarizes the features of the embodiments of the present disclosure so that those skilled in the art can better understand aspects of the present disclosure. Those skilled in the art should appreciate that they may readily use the present disclosure as a basis for designing or modifying other processes and structures for realizing the same purposes and/or achieving the same advantages of the embodiments introduced herein. Those skilled in the art should also recognize that such equivalent constructions do not depart from the spirit and scope of the present disclosure, and that they can be variously modified, substituted, and altered herein without departing from the spirit and scope of the present disclosure.

1. A wireless controller, used in a bicycle comprising at least one of controllable devices, wherein the wireless controller comprises:
a housing;
a wireless communication unit, disposed in the housing, and configured to receive and transmit at least one signal;
a control unit, disposed in the housing and electrically connected to the wireless communication unit, wherein the control unit is configured to generate a control signal in response to a user command, and transmit the control signal to the controllable device of the bicycle via the wireless communication unit to activate the controllable device of the bicycle;
a rotary knob, disposed outside the housing and connected to the control unit, wherein the rotary knob is configured to generate the user command to the control unit through a rotation operation; and
a plurality of buttons, arranged outside the housing and connected to the control unit, wherein the buttons are configured to generate the user command to the control unit through a pressing operation.

2. The wireless controller of claim 1, wherein the at least one of the controllable devices comprises a shock absorber, the shock absorber comprises a hydraulic unit, wherein in response to the rotation operation of rotating the rotary knob in a first rotation direction or the pressing operation of pressing a first one of the buttons, the generated user command corresponds to the control signal that activates the hydraulic unit of the shock absorber to increase a damping value of the shock absorber, and in response to the rotation operation of rotating the rotary knob in a second rotation direction or the pressing operation of pressing a second one of the buttons, the generated user command corresponds to the control signal that activates the hydraulic unit of the shock absorber to decrease the damping value of the shock absorber, wherein the first rotation direction is opposite to the second rotation direction.

3. The wireless controller of claim 1, wherein the at least one of the controllable devices comprises a telescopic seat pillar structure, the telescopic seat pillar structure comprises a motor unit, wherein in response to the rotation operation of rotating the rotary knob in a first rotation direction or the pressing operation of pressing a first one of the buttons, the generated user command corresponds to the control signal that activates the motor unit of the telescopic seat pillar structure to extend a telescopic length of the telescopic seat pillar structure, and in response to the rotation operation of rotating the rotary knob in a second rotation direction or the pressing operation of pressing a second one of the buttons, the generated user command corresponds to the control signal that activates the motor unit of the telescopic seat pillar structure to shorten the telescopic length of the telescopic seat pillar structure, wherein the first rotation direction is opposite to the second rotation direction.

4. The wireless controller of claim 3, further comprising:
another one button, disposed outside the housing and connected to the control unit, wherein the other one button is configured to generate the user command to the control unit through the pressing operation, and in response to the pressing operation of pressing the other one button, the generated user command corresponds to the control signal that activates the motor unit to adjust the telescopic length of the telescopic seat pillar structure to be a maximum length or a minimum length.

5. The wireless controller of claim 1, wherein the at least one of the controllable devices comprises a lighting device, the lighting device comprises a driving unit, wherein in response to the rotation operation of rotating the rotary knob in a first rotation direction or the pressing operation of pressing a first one of the buttons, the generated user command corresponds to the control signal that activates the driving unit of the lighting device to increase brightness of the lighting device, and in response to the rotation operation of rotating the rotary knob in a second rotation direction or the pressing operation of pressing a second one of the buttons, the generated user command corresponds to the control signal that activates the driving unit of the lighting device to decrease the brightness of the lighting device, wherein the first rotation direction is opposite to the second rotation direction.

6. The wireless controller of claim 1, further comprising:
an acceleration sensing unit, electrically connected to the control unit, configured to sense an acceleration variation to generate an acceleration signal; and
a gyroscope unit, electrically connected to the control unit, configured to sense an angular momentum variation to generate an angular velocity signal, wherein the control unit is further configured to generate a velocity value based on the acceleration signal and the angular velocity signal.

7. The wireless controller of claim 6, further comprising:
a display unit, electrically connected to the control unit, configured to display the velocity value.

8. The wireless controller of claim 1, further comprising:
a display unit, electrically connected to the control unit;
wherein the bicycle further comprises at least one tire pressure sensor, and the display unit is configured to display tire pressure information of the at least one tire pressure sensor.

9. The wireless controller of claim 1, further comprising:
a display unit, electrically connected to the control unit;
wherein the at least one of the controllable devices comprises a shock absorber or a telescopic seat pillar structure, and the display unit is configured to display damping value information of the shock absorber or telescopic length information of the telescopic seat pillar structure.

10. The wireless controller of claim 1, further comprising:
an acceleration sensing unit, electrically connected to the control unit, configured to sense an acceleration variation to generate an acceleration signal; and
a gyroscope unit, electrically connected to the control unit, configured to sense an angular momentum variation to generate an angular velocity signal, wherein the control unit is further configured to generate a gravity value based on the acceleration signal and the angular velocity signal.

11. The wireless controller of claim 10, wherein the at least one of the controllable devices comprises a shock absorber, and in response to a smart mode, when a damping value of the shock absorber corresponding to the gravity value generated by the control unit is between a lower limitation value and an upper limitation value, the control unit generates the control signal for adjusting the damping value of the shock absorber according to the gravity value.

12. The wireless controller of claim 11, wherein the smart mode is switched to be one of a road mode, an off-road mode and a customized mode, and only when the damping value of the shock absorber corresponding to the gravity value generated by the control unit is between a set lower limitation value and a set upper limitation value of the current smart mode, the control unit generates the control signal for adjusting the damping value of the shock absorber according to the gravity value, wherein a set upper limitation value set of the off-road mode is larger than a set upper limitation value set of the road mode, a set lower limitation value set of the off-road mode is larger than a set lower limitation value set of the road mode, and a upper limitation value and a lower limitation value of the customized mode are determined by a user.

13. The wireless controller of claim 1, further comprising:
a distance sensing unit, disposed outside the housing and electrically connected to the control unit, wherein the distance sensing unit is configured to transmit and receive a sensing signal, and determine a distance between an object and the wireless controller based on a time difference between transmission and reception of the sensing signal.

14. The wireless controller of claim 13, wherein the control unit is further configured to generate the control signal in response to the distance of the object from the wireless controller, and transmit the control signal to the controllable device of the bicycle via the wireless communication unit to activate the controllable device of the bicycle.
